(19) United States
(12) Patent Application Publication
(10) Pub. No.: US 2024/0152066 A1
(43) Pub. Date: May 9, 2024

(54) PRINTING TONER CONTAINING SUBLIMABLE DYE AND TWO COMPONENT DEVELOPER INCLUDING SAME

(71) Applicant: SHARP KABUSHIKI KAISHA, Osaka (JP)

(72) Inventors: Takao YAMADA, Osaka (JP); OSAMU WADA, Osaka (JP)

(73) Assignee: SHARP KABUSHIKI KAISHA, Osaka (JP)

(21) Appl. No.: 18/379,657

(22) Filed: Oct. 13, 2023

(30) Foreign Application Priority Data
Nov. 7, 2022 (JP) 2022-178236

(51) Int. Cl. G03G 9/097; G03G 9/087; G03G 9/09

(52) U.S. Cl. CPC G03G 9/09733; G03G 9/08724; G03G 9/08755; G03G 9/0924; G03G 9/09708

(57) ABSTRACT

The problem is solved by a printing toner containing sublimable dye including: toner base particles at least including a binder resin, a disperse dye, and a mold release agent; and an external additive externally added to surfaces of the toner base particles, in which the toner base particles include the binder resin in a proportion of 50% to 95% by mass in the toner base particles, and include, as the binder resin, an aliphatic polyester-based resin in a proportion of 20% to 70% by mass in the toner base particles; and the disperse dye is a sublimable dye.

### BACKGROUND OF THE INVENTION

### Field of the Invention

The present disclosure relates to a printing toner containing sublimable dye and a two component developer including same.

### Description of the Background Art

Electrophotographic dyeing methods for dyeing hydrophobic fibers typified by polyester fabric are roughly divided into (1) a direct method in which after directly applying a toner to a material to be dyed, the material to be dyed is dyed with a dye in the toner through heat treatment, and a resin, a mold release agent, and the like other than the dye are dissolved by alkali washing and then removed; and (2) a sublimation transfer method in which after applying a toner to an intermediate recording medium such as paper, a material to be dyed is superimposed on a surface of the intermediate recording medium to which the toner has been applied, followed by heat and pressurization treatment to sublimate a dye in the toner and transfer same to the material to be dyed.

Among these dyeing methods, the sublimation transfer method can dye fibers with the dye alone from the intermediate recording medium among multiple components constituting the toner, and components constituting the toner other than the dye do not attach to the material to be dyed (fabric to be dyed). For this reason, the sublimation transfer method is considered to be suited to dyeing for uses in which texture is seen as important like clothing items such as sports apparel and interior accessories such as seats and sofas.

Disperse dyes and oil-soluble dyes which are suitable to dye hydrophobic fibers are used as a dye in a toner used for the sublimation transfer method, and an easily sublimating-type dye (sublimable dye) with excellent suitability for sublimation transfer to hydrophobic fibers through heat treatment is particularly used among them.

In addition, the sublimation transfer method is advantageous not only because the sublimation transfer method does not need steps for washing, drying, and the like, and the number of steps for dyeing is dramatically reduced, but also because a line for washing and drying, a washing water treatment facility, and the like, which are costly and require a large-scale space and a large amount of running energy, become unnecessary.

Accordingly, the sublimation transfer method is considered as an excellent dyeing method capable of dyeing even a small-scale space.

On the other hand, ink-jet methods are generally used as a method for dyeing fibers utilizing the sublimation transfer method.

However, the sublimation transfer method in an ink-jet manner has, for example, the following problem: an organic solvent, which is one component constituting ink, volatilizes due to heat for transferring a dye to pollute a working environment.

In contrast, the sublimation transfer method in an electrophotographic manner attracts attention, recently, since no volatile component is present in the toner thereof, not causing pollution of a working environment.

A toner containing a polyester-based resin, a sublimable dye, at least one oil-soluble dye, and carnauba wax is suggested as a toner used in the sublimation transfer method in which dyeing is carried out in such an electrophotographic manner by attaching the toner to an intermediate recording medium, and sublimating a dye contained in the toner attached to the intermediate recording medium and transferring same to a material to be dyed, for example.

When printing on fabric is carried out by the sublimation transfer method in an electrophotographic manner using a toner including, as a binder resin, a polyester-based resin excellent in low-temperature fixability, there has been the following problem: sublimation transfer efficiency against fabric is low, that is, the amount of a dye transferred to the fabric is made small, leading to decrease in dyeing concentration, and a sufficient dyeing concentration cannot be obtained even when the amount of the disperse dye in the toner is increased.

The present disclosure has thus been made in view of the above circumstances, and an object thereof is to provide a printing toner containing sublimable dye capable of dyeing a material to be dyed at a high concentration with high transfer efficiency by a sublimation transfer method in an electrophotographic manner.

### SUMMARY OF THE INVENTION

As a result of intensive studies to solve the above problem, the present inventors have found that a toner including an aliphatic polyester-based resin having no bisphenol A skeleton as a binder resin and a sublimable dye as a disperse dye can dye, by a sublimation transfer method in an electrophotographic manner, a material to be dyed at a high concentration with high transfer efficiency to complete the present disclosure.

The above described prior art does not disclose using a certain amount of an aliphatic polyester-based resin having no bisphenol A skeleton as a binder resin.

According to the present disclosure, provided is a printing toner containing sublimable dye including: toner base particles at least including a binder resin, a disperse dye, and a mold release agent; and an external additive externally added to surfaces of the toner base particles, in which the toner base particles include the binder resin in a proportion of 50% to 95% by mass in the toner base particles, and include, as the binder resin, an aliphatic polyester-based resin in a proportion of 20% to 70% by mass in the toner base particles; and the disperse dye is a sublimable dye.

In addition, according to the present disclosure, provided is a two component developer including the above-described printing toner containing sublimable dye and a carrier.

According to the present disclosure, a printing toner containing sublimable dye capable of dyeing, by a sublimation transfer method in an electrophotographic manner, a material to be dyed at a high concentration with high transfer efficiency can be provided.

### BRIEF DESCRIPTION OF THE DRAWINGS

FIG. 1 is a diagram illustrating the relation between a polyester-based resin having a bisphenol A skeleton, which is a binder resin, and a dye (anthraquinone skeleton alone).

FIG. 2 is a diagram illustrating the relation between an aliphatic polyester-based resin, which is a binder resin, and a dye (anthraquinone skeleton alone).

### DESCRIPTION OF THE PREFERRED EMBODIMENTS

(1) Printing Toner Containing Sublimable Dye

A printing toner containing sublimable dye of the present disclosure includes: toner base particles at least including a binder resin, a disperse dye, and a mold release agent; and an external additive externally added to surfaces of the toner base particles, in which the toner base particles include the binder resin in a proportion of 50% to 95% by mass in the toner base particles, and include, as the binder resin, an aliphatic polyester-based resin in a proportion of 20% to 70% by mass in the toner base particles; and the disperse dye is a sublimable dye.

The present inventors have found that disperse dyes easily bind to double bonds of a polyester-based resin having a bisphenol A skeleton, which is used as a binder resin for conventional printing toners containing sublimable dye, when a dye is transferred to fabric, a large amount of the dye remains in the binder resin, and the dyeing concentration decreases. Therefore, the present inventors have found that attachment of a dye to a binder resin is suppressed by reducing the blending ratio of the polyester-based resin having a bisphenol A skeleton in the binder resin and blending, instead thereof, a certain amount of a polyester-based resin (aliphatic polyester-based resin) having no bisphenol A skeleton, transfer efficiency can be thereby improved, and the image concentration can be improved.

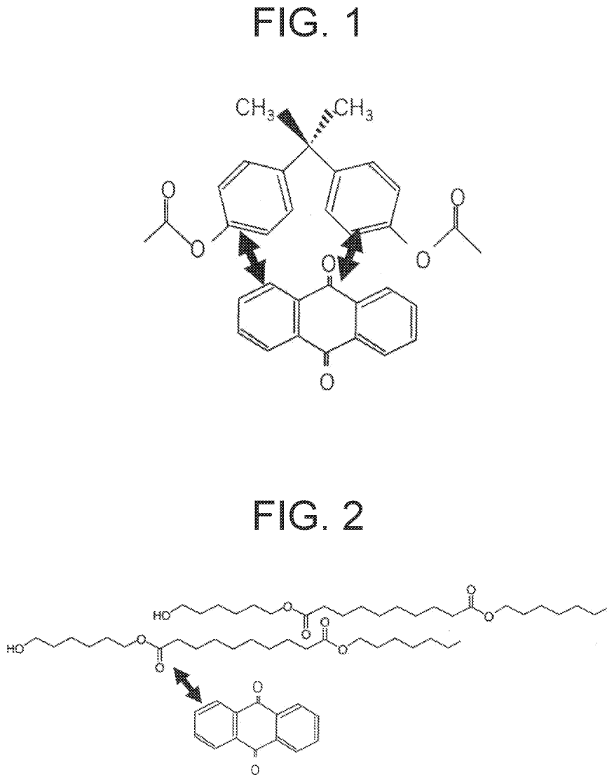

FIG. 1 is a diagram illustrating the relation between a polyester-based resin (upper side) having a bisphenol A skeleton, which is a binder resin, and a dye (anthraquinone skeleton alone, lower side), indicating that sublimation transfer is inhibited because benzene rings in the bisphenol A skeleton have double bonds, van der Waals' force with the anthraquinone skeleton is strengthened (arrows in the drawing), the resin easily traps the dye, molecules hardly sterically overlap each other, and many gaps into which the dye enters are present. FIG. 2 is a diagram illustrating the relation between an aliphatic polyester-based resin (upper side), which is a binder resin, and a dye (anthraquinone skeleton alone, lower side), indicating that sublimation transfer is hardly inhibited because the structure of the binder resin becomes a long hydrocarbon chain, the number of double bonds trapping the dye is small, molecular chains sterically overlap each other, and gaps into which the dye enters are eliminated.

(1-1) Binder Resin

The binder resin included in the printing toner containing sublimable dye of the present disclosure at least includes: a polyester-based resin (hereinafter, also referred to as the “polyester-based resin”) like a polyester-based resin having a bisphenol A skeleton conventionally widely used; and an “aliphatic polyester-based resin” having no bisphenol A skeleton.

(1-1-1) Polyester-Based Resin

The polyester-based resin is usually obtained through condensation polymerization reaction or esterification reaction and transesterification reaction of one or more kinds selected from dihydric alcohol components and trihydric or higher polyhydric alcohol components with one or more kinds selected from dicarboxylic acids and tricarboxylic or higher polycarboxylic acids, using a known method.

Conditions for the condensation polymerization reaction may be appropriately set depending on reactivity of monomer components, and the reaction may be terminated at a time when the polymer has preferred physical properties. For example, the reaction temperature is about 170° C. to 250° C., and the reaction pressure is about 5 mmHg to normal pressure.

Taking long-term durability of the toner into consideration, examples of the dihydric alcohol components include alkyleneoxide adducts of bisphenol A such as polyoxypropylene(2.2)-2,2-bis(4-hydroxyphenyl)propane, polyoxypropylene(3.3)-2,2-bis(4-hydroxyphenyl)propane, polyoxypropylene(2.0)-2,2-bis(4-hydroxyphenyl)propane, polyoxypropylene(2.0)-polyoxyethylene(2.0)-2,2-bis(4-hydroxyphenyl)propane, and polyoxypropylene(6)-2,2-bis(4-hydroxyphenyl)propane; bisphenol A; propylene adducts of bisphenol A; ethylene adducts of bisphenol A; and hydrogenated bisphenol A.

Examples of the trihydric or higher polyhydric alcohol components include sorbitol, 1,2,3,6-hexanetetrol, 1,4-sorbitan, pentaerythritol, dipentaerythritol, tripentaerythritol, sucrose (saccharose), 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene. In the present disclosure, one kind of the dihydric alcohol components and trihydric or higher polyhydric alcohol components described above may be used alone, or two or more kinds thereof may be used in combination.

Examples of the dicarboxylic acids include maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, n-dodecenyl succinic acid, n-dodecyl succinic acid, n-octylsuccinic acid, isooctenylsuccinic acid, isooctylsuccinic acid, and acid anhydrides and lower alkyl esters thereof.

Examples of the tricarboxylic or higher polycarboxylic acids include 1,2,4-benzenetricarboxylic acid, 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxylic-2-methyl-2-methylenecarboxypropane, 1,2,4-cyclohexanetricarboxylic acid, tetra(methylenecarboxylic)methane, 1,2,7,8-octanetetracarboxylic acid, pyromellitic acid, Empol trimer acid, and acid anhydrides and lower alkyl esters thereof.

In the present disclosure, one kind of the dicarboxylic acids and the tricarboxylic or higher polycarboxylic acids described above may be used alone, or two or more kinds thereof may be used in combination.

The mass average molecular weight of the polyester-based resin is preferably 3,000 to 50,000. When the mass average molecular weight is less than 3,000, releasability on the high temperature side of a fixable region (non-offset region) may deteriorate. On the other hand, when the mass average molecular weight exceeds 50,000, low-temperature fixability may deteriorate.

The mass average molecular weight of the polyester-based resin is more preferably 4,500 to 50,000 and still more preferably 4,500 to 40,000.

The glass transition temperature Tg of the polyester-based resin is preferably 40° C. to 70° C. When the glass transition temperature Tg is less than 40° C., blocking, which is thermal aggregation of toner, may occur inside an image forming device. On the other hand, when the glass transition temperature exceeds 70° C., fixability of the toner to a recording medium decreases, and fixation failure may occur.

The glass transition temperature Tg of the polyester-based resin is more preferably 55° C. to 70° C. and still preferably 55° C. to 65° C.

The content of the binder resin in the toner base particles is not particularly limited and can be selected, as appropriate, according to a purpose, and an indication thereof is usually 50% to 95% by mass based on the toner base particles.

When the content of the binder resin in the toner base particles is less than 50% by mass, the disperse dye is poorly dispersed in the toner, and deterioration of electric characteristics of the toner may be caused. On the other hand, when the content of the binder resin in the toner base particles exceeds 95% by mass, decrease in dyeing concentration may be observed.

The content of the binder resin is preferably 60% to 95% by mass and still more preferably 65% to 95% by mass.

(1-1-2) Aliphatic Polyester-Based Resin

The aliphatic polyester-based resin is preferably a polycondensate of a carboxylic acid component and an alcohol component containing an aliphatic diol having a hydroxy group binding to a secondary carbon atom.

The number of carbon atoms in the aliphatic diol having a hydroxy group binding to a secondary carbon atom is preferably 3 or more and preferably 6 or less and more preferably 4 or less.

The aliphatic diol having a hydroxy group binding to a secondary carbon atom includes 1,2-propanediol, 1,2-butanediol, 1,3-butanediol, 2,3-butanediol, 1,2-pentanediol, 1,3-pentanediol, 2,3-pentanediol, and 2,4-pentanediol. Among them, 1,2-propanediol and 2,3-butanediol are preferable, and 1,2-propanediol is more preferable.

The content of the aliphatic diol having a hydroxy group binding to a secondary carbon atom is preferably 50 mol % or more, more preferably 60 mol % or more, still more preferably 70 mol % or more, and further preferably 80 mol % or more in the alcohol component, from the viewpoint of preservability under a high temperature and high humidity environment.

The alcohol component desirably contains an α,ω-aliphatic diol having a hydroxy group at a terminal of the carbon chain in addition to the aliphatic diol having a hydroxy group binding to a secondary carbon atom, from the viewpoint of low-temperature fixability.

The number of carbon atoms in the α,ω-aliphatic diol, which is preferably an α,ω-linear alkanediol, is preferably 2 or more and more preferably 3 or more and preferably 6 or less and more preferably 5 or less.

The α,ω-aliphatic diol includes ethylene glycol, 1,3-propanediol, 1,4-butanediol, 1,5-pentanediol, 1,6-hexanediol, 1,4-butenediol, and neopentyl glycol. Among them, an α,ω-linear alkanediol is preferable, and 1,4-butanediol is more preferable.

The content of the α,ω-aliphatic diol, preferably an α,ω-linear alkanediol is preferably 10 mol % or more and more preferably 20 mol % or more in the alcohol component, from the viewpoint of low-temperature fixability, and the content is preferably 50 mol % or less, more preferably 40 mol % or less, still more preferably 30 mol % or less, and further preferably 20 mol % or less from the viewpoint of preservability under a high temperature and high humidity environment.

The mole ratio (aliphatic diol having hydroxy group binding to secondary carbon atom/α,ω-aliphatic diol) between the aliphatic diol having a hydroxy group binding to a secondary carbon atom and the α,ω-aliphatic diol in the alcohol component is preferably 1 or more, more preferably 2 or more, and still more preferably 3 or more from the viewpoint of preservability under a high temperature and high humidity environment, and the ratio is preferably 10 or less, more preferably 8 or less, and still more preferably 5 or less from the viewpoint of low temperature fixability.

Meanwhile, as a dicarboxylic acid-based compound, an aromatic dicarboxylic acid-based compound is preferable from the viewpoint of durability and an aliphatic dicarboxylic acid-based compound is preferable from the viewpoint of low-temperature fixability.

Incidentally, in the present disclosure, carboxylic acid-based compounds include not only free acids but also anhydrides decomposing during reaction and generating acids, and alkyl esters having 1 or more and 3 or less carbon atoms.

The aromatic dicarboxylic acid-based compound includes phthalic acid, isophthalic acid, terephthalic acid; anhydrides of these acids; and alkyl (carbon number: 1 to 3) esters of these acids. Among them, terephthalic acid and isophthalic acid are preferable, and terephthalic acid is more preferable.

The content of the aromatic dicarboxylic acid-based compound in the carboxylic acid component is preferably 30 mol % or more and more preferably 40 mol % or more from the viewpoint of preservability of the toner and is preferably 80 mol % or less from the viewpoint of low-temperature fixability.

On the other hand, the number of carbon atoms in the aliphatic dicarboxylic acid-based compound is preferably 4 or more and is preferably 14 or less and more preferably 12 or less from the viewpoint of availability.

The aliphatic dicarboxylic acid-based compound includes succinic acid (carbon number: 4), fumaric acid (carbon number: 4), glutaric acid (carbon number: 5), adipic acid (carbon number: 6), suberic acid (carbon number: 8), azelaic acid (carbon number: 9), sebacic acid (carbon number: 10), dodecanedioic acid (carbon number: 12), tetradecanedioic acid (carbon number: 14), succinic acid having an alkyl group or an alkenyl group in a side chain thereof, anhydrides of these acids, and alkyl esters of these acids having 1 to 3 carbon atoms. Incidentally, the number of carbon atoms in an alkyl group of the alkyl ester moiety is not included in the number of carbon atoms in the aliphatic dicarboxylic acid-based compound.

The content of the aliphatic dicarboxylic acid-based compound in the carboxylic acid component is preferably 5 mol % or more and more preferably 10 mol % or more from the viewpoint of low-temperature fixability and is preferably 50 mol % or less, more preferably 40 mol % or less, and still more preferably 30 mol % or less from the viewpoint of preservability. The carboxylic acid component preferably contains an aromatic tricarboxylic or higher polycarboxylic acid-based compound from the viewpoints of preservability and durability. The aromatic tricarboxylic or higher polycarboxylic acid-based compound includes 1,2,4-benzenetricarboxylic acid (trimellitic acid), 2,5,7-naphthalenetricarboxylic acid, pyromellitic acid, and acid anhydrides thereof and lower alkyl (carbon number: 1 to 3) esters thereof. Among them, trimellitic acid-based compounds are preferable.

The content of the aromatic tricarboxylic or higher polycarboxylic acid-based compound based on 100 moles of the alcohol component is preferably 3 moles or more, more preferably 5 moles or more, and still more preferably 7 moles or more from the viewpoint of raising the softening point, and is preferably 20 moles or less, more preferably 15 moles or less, and still more preferably 13 moles or less from the viewpoint of lowering the softening point and the viewpoint of low-temperature fixability.

From the viewpoint of adjusting the molecular weight, the alcohol component may contain, as appropriate, a monohydric alcohol, and the carboxylic acid component may contain, as appropriate, a monocarboxylic acid-based compound.

The equivalent mole ratio (COOH group/OH group) between the carboxylic acid component and the alcohol component in the polyester-based resin is preferably 0.7 or more and more preferably 0.8 or more, and preferably 1.5 or less and more preferably 1.1 or less, from the viewpoint of adjusting the softening point of the resin.

The mass average molecular weight of the aliphatic polyester-based resin is preferably 3,000 to 60,000.

When the mass average molecular weight is less than 3,000, releasability on the high temperature side of a fixable region (non-offset region) may deteriorate. On the other hand, when the mass average molecular weight exceeds 60,000, adhesiveness on the low temperature side of a fixable region (non-offset region) may deteriorate.

The mass average molecular weight of the aliphatic polyester-based resin is more preferably 4,000 to 50,000 and still more preferably 4,500 to 35,000.

The number average molecular weight of the aliphatic polyester-based resin is preferably 3,000 to 12,000.

When the number average molecular weight is less than 3,000, releasability on the high temperature side of a fixable region (non-offset region) may deteriorate. On the other hand, when the number average molecular weight exceeds 12,000, adhesiveness on the low temperature side of a fixable region (non-offset region) may deteriorate.

The number average molecular weight of the aliphatic polyester-based resin is more preferably 4,000 to 10,000 and still more preferably 4,500 to 6,000.

The glass transition temperature Tg of the aliphatic polyester-based resin is preferably 59° C. to 64° C.

When the glass transition temperature Tg is less than 59° C., blocking, which is thermal aggregation of toner, may occur inside an image forming device. On the other hand, when the glass transition temperature Tg exceeds 64° C., fixability of the toner to a recording medium decreases, and fixation failure may occur.

The glass transition temperature Tg of the aliphatic polyester-based resin is more preferably 60° C. to 64° C. and still more preferably 60° C. to 62° C.

The content of the aliphatic polyester-based resin in the toner base particles is not particularly limited and can be selected, as appropriate, according to a purpose, and an indication thereof is usually 20% to 70% by mass based on the toner base particles.

When the content of the aliphatic polyester-based resin in the toner base particles is less than 20% by mass, sublimation performance of the dye may deteriorate. On the other hand, when the content of the aliphatic polyester-based resin in the toner base particles exceeds 70% by mass, durability of the toner may deteriorate.

The content of the binder resin is more preferably 40% to 50% by mass.

(1-1-3) Crystalline Polyester-Based Resin

In the printing toner containing sublimable dye of the present disclosure, the binder resin preferably includes a crystalline polyester-based resin in the toner base particles.

When the toner is exposed to high temperature in, for example, a fixing step, part of the disperse dye sublimates, the concentration of a final dyed product is likely to be short, bonding between the dye and the binder resin is strengthened, which may cause decrease in sublimation transfer efficiency. The crystalline polyester-based resin can fix the toner to an intermediate recording medium at low-temperature and thus can resolve or at least reduce problems arising when the toner as described above is exposed to high temperature.

In the present disclosure, crystalline resins are distinguished from non-crystalline resins by a crystallinity index. Resins with a crystallinity index falling within a range of 0.6 to 1.5 are taken as crystalline resins, and resins with a crystallinity index of less than 0.6 or more than 1.5 are taken as non-crystalline resins. Resins with a crystallinity index exceeding 1.5 are non-crystalline. Resins with a crystallinity index less than 0.6 have low crystallinity, and large part thereof is non-crystalline.

The crystallinity index is a physical property indicating the crystallization degree of a resin and is defined by the ratio (softening temperature/endothermic maximum peak temperature) between a softening temperature and an endothermic maximum peak temperature. The endothermic maximum peak temperature means the temperature of a peak located on the most high-temperature side among endothermic peaks observed. The highest peak temperature is taken as a melting point for the crystalline polyester-based resin, the peak located on the most high-temperature side is taken as a glass transition temperature for a non-crystalline polyester-based resin.

The degree of crystallization can be controlled by adjusting the type and the ratio of raw material monomers, production conditions (e.g., reaction temperature, reaction time, cooling rate), and the like.

The crystalline polyester-based resin is a polyester-based resin having a crystallinity index of 0.6 to 1.5, but is preferably a polyester-based resin having a crystallinity index of 0.8 to 1.2. The acid value of the crystalline polyester-based resin is preferably 5 to 20 mgKOH/g. The hydroxyl value of the crystalline polyester-based resin is preferably 5 to 20 mgKOH/g. The molecular weight of the crystalline polyester-based resin is preferably 3,000 to 100,000 in terms of mass average molecular weight (Mw) and is preferably 5,000 to 40,000 in terms of number average molecular weight (Mn). In the present disclosure, the weight average molecular weight and the number average molecular weight are values measured by gel permeation chromatography (GPC), in which chloroform is used as a mobile phase, and polystyrene is used as a standard substance.

The softening temperature of the crystalline polyester-based resin is preferably 60° C. to 105° C.

The content of the crystalline polyester-based resin in the toner base particles is not particularly limited but is usually 2% to 10% by mass.

When the content of the crystalline polyester-based resin in the toner base particles is less than 2% by mass, sublimation performance of the dye may deteriorate. On the other hand, when the content of the crystalline polyester-based resin in the toner base particles exceeds 10% by mass, blocking resistance of the toner may deteriorate.

A preferable blending amount of the crystalline polyester-based resin is 4% to 8% by mass. Accordingly, in the printing toner containing sublimable dye of the present disclosure, the toner base particles preferably include the crystalline polyester-based resin in a proportion of 2% to 10% by mass in the toner base particles.

(1-1-4) Polyvinyl Butyral Resin

In the printing toner containing sublimable dye of the present disclosure, the binder resin preferably includes a polyvinyl butyral resin in the toner base particles.

The polyvinyl butyral resin has excellent dye dispersibility, improves dispersibility of the disperse dye, and can improve preservation stability.

The content of the polyvinyl butyral resin in the toner base particles is not particularly limited, can be selected, as appropriate, according to a purpose, and is preferably 2% to 5% by mass and more preferably 3% to 4% by mass.

When the content of the polyvinyl butyral resin is less than 2% by mass, dispersibility of the dye may deteriorate. On the other hand, when the content of the polyvinyl butyral resin exceeds 5% by mass, blocking resistance of the toner may deteriorate.

Accordingly, in the printing toner containing sublimable dye of the present disclosure, the toner base particles preferably include the polyvinyl butyral resin in a proportion of 2% to 5% by mass in the toner base particles.

(1-2) Disperse Dye

The disperse dye is not particularly limited but is preferably a dye (sublimable dye) having suitability for sublimation transfer.

The “dye having suitability for sublimation transfer” means dyes providing a contamination (polyester) test result of usually grade 3-4 or lower preferably grade 3 or lower in the dry-heat treatment test (C method) in accordance with “test methods for color fastness to dry heat JIS L0879:2005 (confirmed in 2010, revised on Jan. 20, 2005, issued by Japanese Standards Association).” Among such dyes, known dyes include the following dyes.

Yellow dyes include C.I. Disperse Yellow 3, 7, 8, 23, 39, 51, 54, 60, 71, 86; C.I. Solvent Yellow 114, 163, and the like.

Orange dyes include C.I. Disperse Orange 1, 1:1, 5, 20, 25, 25:1, 33, 56, 7, and the like.

Brown dyes include C.I. Disperse Brown 2 and the like.

Red dyes include C.I. Disperse Red 11, 50, 53, 55, 55:1, 59, 60, 65, 70, 75, 93, 146, 158, 190, 190:1, 207, 239, 240, C.I. Vat Red 41, and the like.

Violet dyes include C.I. Disperse Violet 8, 17, 23, 27, 28, 29, 36, 57, and the like.

Blue dyes include C.I. Disperse Blue 19, 26, 26:1, 35, 55, 56, 58, 64, 64:1, 72, 72:1, 81, 81:1, 91, 95, 108, 131, 141, 145, 359, 360, C.I. Solvent Blue 3, 63, 83, 105, 111, and the like.

In the printing toner containing sublimable dye of the present disclosure, one kind of the sublimable dye described above may be used alone, or two or more kinds thereof may be used in combination, and the dyes of each combination may have different colors or the same color. Specifically, multiple sublimable dyes, for example, a blue dye as a main component, a yellow dye, and a red dye may be blended, as appropriate, to achieve a hue entirely different from the original dyes such as black. In addition, multiple sublimable dyes may be blended to finely adjust the color to achieve a preferable color tone, and an intermediate color may be exhibited.

The content of the sublimable dye in the toner base particles is not particularly limited, may be selected, as appropriate, according to a purpose, and is usually 1% to 40% by mass and preferably 2% to 35% by mass.

When the content of the sublimable dye is less than 1%, the dyeing concentration may decrease. On the other hand, when the content of the sublimable dye exceeds 40%, the dye is poorly dispersed in the toner, and deterioration of electric characteristics of the toner may be caused.

(1-3) Mold Release Agent

The mold release agent is not particularly limited, but a mold release agent commonly used in the art can be used. Examples thereof include wax such as petroleum-based wax including paraffin wax and derivatives thereof, hydrocarbon-based wax including polyethylene wax and derivatives thereof, carnauba wax, rice wax, and candelilla wax, and these kinds of wax are preferably used.

It has been considered so far that wax as a mold release agent inhibits, through a gas barrier, sublimation transfer in a sublimation transfer toner. However, the present inventors have found in the current study that by virtue of using an aliphatic polyester-based resin as the binder resin, no sublimation transfer inhibition effect due to wax is provided, the binder resin is further prevented from migrating to a material to be dyed during sublimation transfer, and friction fastness of the material to be dyed improves.

The content of the mold release agent in the toner base particles is not particularly limited, can be selected, as appropriate, according to a purpose, and is preferably 5% to 15% by mass and more preferably 7% to 12% by mass.

When the content of the mold release agent is less than 5% by mass, an offset to a fixing roller may occur. On the other hand, when the content of the mold release agent exceeds 15% by mass, fixation failure to an intermediate recording medium may occur.

Accordingly, the printing toner containing sublimable dye of the present disclosure preferably includes wax as the mold release agent in the toner base particles in a proportion of 5% to 15% by mass.

(1-4) Others (Additives)

The printing toner containing sublimable dye of the present disclosure may include a known additive within a range not inhibiting the effects of the present disclosure, if needed.

(1-4-1) Charge Control Agent (CCA)

The printing toner containing sublimable dye of the present disclosure preferably includes a charge control agent in the toner base particles.

The charge control agent is not particularly limited, but a charge control agent for controlling positive charge and a charge control agent for controlling negative charge commonly used in the art can be used.

Examples of the charge control agent for controlling positive charge include nigrosine dyes, basic dyes, quaternary ammonium salts, quaternary phosphonium salts, aminopyrine, pyrimidine compounds, polynuclear polyamino compounds, aminosilane, nigrosine dyes and derivatives thereof, triphenylmethane derivatives, guanidine salts, and amidine salts.

Examples of the charge control agent for controlling negative charge include oil-soluble dyes such as oil black and spilon black, metal-containing azo compounds, azo complex dyes, metal naphthenates, metal complexes and metal salts of salicylic acid and derivatives thereof (metal is chromium, zinc, zirconium, etc.), boron compounds, fatty acid soap, long chain alkyl carboxylic acid salts, and resin acid soap.

In the printing toner containing sublimable dye of the present disclosure, one kind of the charge control agent described above may be used alone, or two or more kinds thereof may be used in combination.

The content of the charge control agent in the toner base particles is not particularly limited, depends on the type of the binder resin, presence or absence of other additives, dispersion manner, or the like, and is difficult to unambiguously define, but may be selected, as appropriate, according to a purpose, and is usually 0.1% to 10% by mass.

When the content of the charge control agent falls within the above range, an image having a high image concentration and extremely high image quality can be formed without impairing various physical properties of the toner.

When the content of the charge control agent is less than 0.1% by mass, charge control performance may not be exhibited. On the other hand, when the content of the charge control agent exceeds 10% by mass, the toner is excessively charged, the effect of the charge control agent is weakened, and electrostatic attraction force toward a developing roller increases, which may cause decrease in flowability of the toner and decrease in the image concentration. The content of the charge control agent is preferably 0.5% to 3.0% by mass and more preferably 0.7% to 2.5% by mass.

(1-4-2) Sublimation Transfer Efficiency Improving Agent

The printing toner containing sublimable dye of the present disclosure preferably includes, in the toner base particles, a fully saturated long chain linear primary alcohol (higher alcohol), that is, a fully saturated linear alcohol as a sublimation transfer efficiency improving agent. Use of a higher alcohol in part of wax as the mold release agent can improve dispersibility of the binder resin and the sublimable dye to improve preservation stability, and contamination of the inside of a printer due to, for example, a carrier can be prevented by absorbing the sublimable dye that have bled out because of shear stress or thermal stress during an electronic photo developing step (step of mixing a carrier and the toner base particles).

In addition, a polymer chain of the binder resin and a long chain of the fully saturated linear alcohol easily tangle, sublimation performance of the sublimable dye is hardly hindered, and sublimation transfer efficiency improves.

Although the fully saturated linear alcohol is not particularly limited, examples thereof include a long chain synthetic alcohol manufactured by Baker Hughes Company, in particular, products named as UNILIN 425 (number average molecular weight: 460, melting point: 91° C.), UNILIN 550 (number average molecular weight: 550, melting point: 99° C.), and UNILIN 700 (number average molecular weight: 700, melting point: 105° C.).

The content of the fully saturated linear alcohol in the toner base particles is not particularly limited and is usually 1% to 8% by mass.

When the content of the fully saturated linear alcohol is less than 1% by mass, the dispersion diameter of the disperse dye may increase. On the other hand, when the content of the fully saturated linear alcohol exceeds 8% by mass, preservation stability may deteriorate.

The content of the fully saturated linear alcohol is more preferably 1% to 8% by mass and still more preferably 3% to 6% by mass.

Accordingly, it is preferable that the printing toner containing sublimable dye of the present disclosure further include, in the toner base particles, the fully saturated linear alcohol as the sublimation transfer efficiency improving agent in a proportion of 1% to 8% by mass.

(1-4-3) Sol Agent

The printing toner containing sublimable dye of the present disclosure preferably includes a sol agent in the toner base particles.

The sol agent herein refers to an “organic substance which is solid at normal temperature and liquefies when heated and is a substance liquifying during sublimation transfer of a dye and functioning to accelerate sublimation transfer.”

When the polyester-based resin as the binder resin and the sol agent are compatible with each other, sublimation inhibition performance of the binder resin declines, and sublimation transfer efficiency improves.

Although the sol agent is not particularly limited, examples thereof include aliphatic ketone compounds such as distearyl ketone and dipalmityl ketone.

The content of the sol agent in the toner base particles is not particularly limited and is usually 2% to 5% by mass.

When the content of the sol agent is less than 2% by mass, aggregates of the disperse dye may be generated. On the other hand, when the content of the sol agent exceeds 5% by mass, preservation stability may deteriorate.

The content of the sol agent is more preferably 3% to 5% by mass and still more preferably 3% to 4% by mass.

Accordingly, in the printing toner containing sublimable dye of the present disclosure, it is preferable that the toner base particles further include, as the sol agent, a fatty acid ketone in a proportion of 2% to 5% by mass in the toner base particles.

(1-5) External Additive

An external additive may be mixed to the toner of the present disclosure serving functions of powder flowability improvement, friction electrification improvement, heat resistance, long-term preservability improvement, cleaning characteristic improvement, photoreceptor surface abrasion characteristic control, and the like.

Examples of the external additive include inorganic fine particles such as silica, titanium oxide, and alumina fine particles having an average particle diameter of 5 to 200 nm. In particular, inorganic fine particles to which hydrophobicity is imparted by subjecting same to surface treatment with a silane coupling agent, a titanium coupling agent, or silicone oil are preferable. Surface-treated inorganic fine particles can suppress decrease in electric resistance and charge amount under high humidity.

The external addition amount of the external additive added to the toner base particles is not particularly limited and is usually 0.01% to 5.0% by mass.

When the external addition amount of the external additive is less than 0.05% by mass, it may be difficult to impart flowability improving effect. On the other hand, when the external addition amount of the external additive exceeds 5.0% by mass, fixability may deteriorate. The external addition amount of the external additive is preferably 0.05% to 4.9% by mass and more preferably 0.5% to 2.0% by mass.

(1-6) Hydrotalcite (CAS No. 11097-59-9)

The printing toner containing sublimable dye of the present disclosure preferably contains, on surfaces of the toner base particles, hydrotalcites (referred to as simply “hydrotalcite” herein) represented by, for example, formula (1):

Mg_{4.3}Al₂(OH)_{12.6}CO₃·mH₂O (1)

(in the formula, m is an integer larger than 0) together with the external additive described in section (1-5), with the crystal surface of the hydrotalcite being highly positively charged.

It is recognized that dyes (including disperse dyes) are adsorbed to hydrotalcites, and the hydrotalcite traps the disperse dye bleeding out when the toner is not used yet and can prevent the disperse dye from contaminating the inside of a printer (e.g., a carrier).

The content of the hydrotalcite is not particularly limited and is usually 0.1% to 0.4% by mass based on the toner base particles.

When the content of the hydrotalcite is less than 0.1% by mass, fusion preventing effect provided by silica may not be provided. On the other hand, when the content of the hydrotalcite exceeds 0.4% by mass, preservation stability may deteriorate.

The content of the hydrotalcite is preferably 0.05% to 4.9% by mass and more preferably 0.5% to 2.0% by mass based on the toner base particles.

Accordingly, it is preferable that in the printing toner containing sublimable dye of the present disclosure, the external additive be externally added to the toner base particles in a proportion of 0.01% to 5.0% by mass, and the hydrotalcite be externally added to the toner base particles in a proportion of 0.1% to 0.4% by mass.

(2) Printing Toner Containing Sublimable Dye Production Method

The printing toner containing sublimable dye of the present disclosure can be produced by a known method and can be produced by, for example, a mixing and kneading step of mixing at least a binder resin, a disperse dye, and a mold release agent and optionally a charge control agent and melting and kneading same, a coarsely pulverizing step of coarsely pulverizing the obtained melt kneaded product, a finely pulverizing step of finely pulverizing the obtained coarsely pulverized product, and a classifying step of classifying the obtained finely pulverized product.

Although the printing toner containing sublimable dye production method of the present disclosure is not limited to the above-described method, dry methods are preferable because the number of steps is small and costs for equipment are low compared to wet methods, and a pulverization method is particularly preferable among others.

Conditions for each of the above-desired steps may be appropriately set according to a target material and desired physical properties.

(2-1) Mixing and Kneading Step

In the mixing step, toner materials including at least the binder resin, the disperse dye, and the mold release agent and a known additive such as the charge control agent optionally blended are mixed, melt, and kneaded to obtain a melt kneaded product.

Dry mixing is preferable, a known device commonly used in the art can be used as a mixer, and examples thereof include a Henschel-type mixing device such as Henschel mixer (product name, manufactured by Mitsui Mining Co., Ltd. (current Nippon Coke and Engineering Co., Ltd.)), SUPER MIXER (product name, KAWATA MFG. CO., LTD.), and MECHANOMILL (product name, manufactured by Okada Seiko Co., Ltd.); and a mixing device such as Ongmill (product name, manufactured by Hosokawa Micron Corporation), Hybridization System (product name, manufactured by Nara Machinery Co., Ltd.), and Cosmo System (product name, manufactured by Kawasaki Heavy Industries, Ltd.).

A known device commonly used in the art can be used as a kneader, and examples thereof include general kneaders such as a twin-screw extruder, a three roll, and Labo Plastomill. Specifically, examples thereof include a single or twin-screw extruder such as TEM-100B (product name, manufactured by Toshiba Machine Co., Ltd.), PCM-65/87, and PCM-30 (which are all product names, manufactured by Ikegai Corp) and an open roll kneader such as Kneadex (product name, manufactured by Mitsui Mining Co., Ltd.). Among them, an open roll kneader is preferable from the points of providing strong shear during kneading and being capable of highly dispersing the disperse dye.

(2-2) Coarsely Pulverizing Step

In the coarsely pulverizing step, the melt kneaded product cooled by a drum flaker is coarsely pulverized to obtain a coarsely pulverized product.

A known device commonly used in the art can be used as a pulverizer, and examples thereof include a cutting mill (manufactured by SEISHIN ENTERPRISE CO., LTD., model: VM-16).

(2-3) Finely Pulverizing Step

In the finely pulverizing step, the mixture obtained in the mixing step is finely pulverized.

A known device commonly used in the art can be used as a pulverizer, and examples thereof include a jet pulverizer conducting pulverization utilizing an ultrasound jet airflow and an impact pulverizer conducting pulverization by introducing a solidified material into a space formed between a rotator (rotor) rotating at high speed and a stator (liner).

(2-4) Classifying Step

In the classifying step, the finely pulverized product obtained in the finely pulverizing step is classified.

A known device commonly used in the art, in particular, a classifier capable of removing excessively pulverized toner particles by centrifugal force and wind power like a wind power slewing classifier (wind power rotary classifier) can be used for classification, and examples thereof include an elbow jet classifier (manufactured by Nittetsu Mining Co., Ltd., model: EJ-LABO).

(2-5) External Addition Step

In an external addition step, the toner base particles obtained in a spheronization step and an external additive and optionally hydrophobic silica particles are mixed, and an external additive is externally added to the toner base particles to obtain a toner.

A known device commonly used in the art can be used as a mixer, and examples thereof include the mixers described in section (2-1) pertaining to the mixing and kneading step.

In the above manner, the toner to which an external additive is externally added if needed can be directly used as a one component developer or can be mixed with a carrier and used as a two component developer. When the toner is used as a one component developer, the toner is used alone without using a carrier. In the case where the toner is used as a one component developer, an image is formed, using a blade and a fur brush, in a manner that the toner is triboelectrically charged with a developing sleeve and attached onto the sleeve, and the toner is thereby conveyed.

(3) Two Component Developer

The two component developer of the present disclosure is characterized by including the toner of the present disclosure and a carrier.

In the case where the toner of the present disclosure is used as a two component developer, the two component developer can be prepared by mixing the toner and the carrier.

A known device commonly used in the art can be used as a mixing device, and examples thereof include a power mixer such as a V-type mixer (product name: V-5, manufactured by TOKUJU CORPORATION).

A blending ratio between the toner and the carrier is preferably a mass ratio of 10:90 to 5:95, for example. That is, the toner concentration in the two component developer is preferably 5% to 10% by mass. The carrier is not particularly limited, a carrier usually used for two component developers can be used, and a coated carrier can be used, for example.

### EXAMPLES

The present disclosure will be specifically described below with reference to examples and comparative examples, but the present disclosure is not limited to the following examples unless it does not depart from the spirit thereof.

### Example 1

Production of Toner Base Particles

Binder resin 1: polyester-based resin (manufactured by Mitsubishi Chemical Corporation, product name: Diacron (registered trademark) FC-2232, mass average molecular weight: 29,730, Tg: 64° C., Tm: 162° C., acid number: 8) 40.0% by mass

Binder resin 2: aliphatic polyester-based resin (polycondensate of a carboxylic acid component and an alcohol component containing an aliphatic diol having a hydroxy group binding to a secondary carbon atom, DIC Corporation, product name: Polylite OD-X-2547, number average molecular weight: 4,500, Tg: 62° C., Tm: 116° C., acid number: 0.3) 45.0% by mass

Disperse dye: sublimable dye Disperse Red 60 (manufactured by ARIMOTO CHEMICAL Co., Ltd., product name: Plast Red 8375-N) 6.0% by mass

Charge control agent: salicylic acid-based compound (manufactured by ORIENT CHEMICAL INDUSTRIES CO., LTD., product name: BONTRON E-84) 1.0% by mass

Mold release agent: purified carnauba wax (manufactured by TOA KASEI CO., LTD., product name: TOWAX-131) 8.0% by mass

The above materials were pre-mixed for five minutes using an airflow mixer (Henschel mixer, manufactured by Mitsui Mining Co., Ltd. (current Nippon Coke and Engineering Co., Ltd.), model: FM20C) and subsequently melt and kneaded, using a twin-screw extruder (manufactured by Ikegai Corp, model: PCM 30), under conditions where the cylinder setting temperature was 110° C., the barrel rotation frequency was 200 rpm, and the raw material supply rate was 15 kg/hour to obtain a melt kneaded product [mixing and kneading step]. The obtained melt kneaded product was cooled by a drum flaker and subsequently coarsely pulverized using a cutting mill (manufactured by SEISHIN ENTERPRISE CO., LTD., model: VM-16) to obtain a coarsely pulverized product [coarsely pulverizing step].

Thereafter, the obtained coarsely pulverized product was finely pulverized using a jet pulverizer (manufactured by Nippon Pneumatic Mfg. Co., Ltd., model: IDS-2) to obtain a finely pulverized product [finely pulverizing step].

The obtained finely pulverized product was classified using Elbow-Jet classifier (manufactured by Nittetsu Mining Co., Ltd., model: EJ-LABO) to obtain toner particles having an average primary particle diameter of 5.5 μm [classifying step].

Into Henschel mixer were put 100 parts by mass of toner particles (toner base particles) with no additive externally added thereto and 1.5 parts by mass of hydrophobic silica fine particles (average primary particle diameter: 7 m, manufactured by NIPPON AEROSIL CO., LTD., product name: fumed silica RY300), and the circumferential velocity at the outermost periphery of a tip end part of a stirring blade was set to 40 m/second, followed by stirring and mixing for one minute to obtain about 2,000 g of a printing toner containing sublimable dye (volume average particle diameter: 5.9 m, variance coefficient: 24%) [external addition step].

Production of Two Component Developer

The obtained printing toner containing sublimable dye and a coated carrier (manufactured by Sharp Corporation, genuine carrier for MX-5111FN) were mixed, for 20 minutes, in a V-type mixer (product name: V-5, manufactured by TOKUJU CORPORATION) so as to provide a toner concentration of 7% by mass to prepare a two component developer.

### Examples 2 to 27

Printing toners containing sublimable dye and two component developers including the printing toners containing sublimable dye were prepared in the same manner as Example 1 except that the materials for the toner base particles and blending amounts thereof were changed to those shown in Tables 1 and 2.

In Examples 2 and 3, the blending amount of the aliphatic polyester-based resin as the binder resin was changed.

In Examples 4 to 7, a crystalline polyester-based resin (manufactured by TOYOBO CO., LTD., product name: VYLON GM-920, number average molecular weight: 30,000, Tm: 107° C.) was further blended as the binder resin.

In Examples 8 to 12, the blending amount of the mold release agent was changed.

In Examples 13 to 15, a fully saturated linear alcohol (manufactured by TOYOCHEM CO., LTD., product name: UNILIN 700, number average molecular weight: 700) was further blended as an additive (sublimation transfer efficiency improving agent).

In Examples 16 to 19, a fatty acid ketone (manufactured by Kao Corporation, product name: KAO WAX T-1) was further blended as an additive (sol agent).

In Examples 21 to 24, a polyvinyl butyral-based resin (manufactured by SEKISUI CHEMICAL CO., LTD., product name: S-LEC BM-1, Tg: 72° C., Tm: 127° C.) as the binder resin was further blended.

In Examples 25 to 27, a hydrotalcite (Kyowa Chemical Industry Co., Ltd., product name: DHT-4A) was further externally added as an external additive.

### Comparative Examples 1 to 5

Printing toners containing sublimable dye and two component developers including the printing toners containing sublimable dye were prepared in the same manner as Example 1 except that the blending amount of the aliphatic polyester-based resin was changed in Comparative Examples 1 to 5, a crystalline polyester-based resin was further blended in Comparative Example 3, a saturated linear alcohol was further blended in Comparative Examples 2 and 4, and a fatty acid ketone was further blended in Comparative Examples 3 and 5, as shown in Table 2.

Evaluation 1: Preservation Stability of Toner

Preservation stability of each toner was evaluated on the basis of the presence or the absence of agglomerate after preserving at high temperature.

Into a plastic container having a volume of 250 mL and having a wide-mouthed cylindrical shape was put 100 g of the toner, and the plastic container was sealed and preserved under a temperature condition of 60° C. for 120 hours. Thereafter, the plastic container is placed on a rotary roller (diameter: 100 mm), and the roller was rotated at a rotation frequency of 120 rpm for three minutes, and the contained toner was stirred. Thereafter, the container was inverted to discharge the toner, the aggregation state of the toner was visually observed, and preservation stability of the toner was evaluated according to the following criteria.
Excellent: flowability was the same as before put into container, and no problem was found in flowability
Good: soft agglomerate was observed but could be loosened with fingers
Fair: toner was discharged from container, but hard agglomerate was observed
Poor: toner was not discharged from container even when container was inverted

Evaluation 2: Filming of Photoreceptor

Each two component developer was charged into a commercially available copying machine (manufactured by Sharp Corporation, model: MX-5111FN) having a developing device, 5000 sheets of a print pattern at a printing rate of 1% were continuously printed under a HH environment (temperature: 35° C., humidity: 80%) using the ISO19752 standard test chart. Thereafter, the photoreceptor and the solid image were visually observed, and filming of the photoreceptor was evaluated according to the following criteria.
Excellent: filming did not occur on photoreceptor, and no problem arose
Good: although filming did not occur on photoreceptor, irregularities due to scratch were observed on surface, but no problem was found in image
Fair: filming slightly occurred on photoreceptor, but no problem was found in image
Poor: filming significantly occurred on photoreceptor, and image had problem

Evaluation 3: Sublimation Transfer Efficiency

Each two component developer was charged into a commercially available copying machine (manufactured by Sharp Corporation, model: MX-5111FN) having a developing device, an A4 test manuscript having a rectangular solid image of 20 mm by 50 mm was printed on an intermediate recording medium (manufactured by Sharp Corporation, product name: PPC paper SF-4AM3), and whether a low-temperature offset occurred or not was investigated. At this time, the toner deposition amount in the solid image part was set to 0.5 mg/cm², and the temperature of the fixing roller was set to 135° C.

With respect to the intermediate recording medium obtained by two component development, the magenta color dyeing concentration in the part corresponding to each print output % of the intermediate recording medium was measured before and after sublimation transfer through heat treatment using a spectrophotometer (manufactured by GretagMacbeth LLC, product name: SpectroEye RD-19).

In addition, sublimation transfer efficiency was calculated, using the following equation, from the dye concentration SDb before transfer and the dye concentration SDa after transfer attached to the intermediate recording medium, and the sublimation transfer efficiency was evaluated according to the following criteria.

Sublimation transfer efficiency (%)=(SDa−SDb)/(SDa)×100
Excellent: 50% or more (possible to use practically)
Good: 45% or more and less than 50% (possible to use practically)
Fair: 40% or more and less than 45% (possible to use practically)
Poor: less than 40% (impossible to use practically)

Evaluation 4: Fog

The whiteness (fog when printing 5K) of the part with no image formed thereon after printing was measured using a whiteness meter (manufactured by NIPPON DENSHOKU INDUSTRIES CO., LTD., model: ZE6000), and fog was evaluated according to the following criteria from the difference from whiteness of paper before printing measured in advance. Initial fog means a fog value after changing the developer and setting up the machine, 5 k fog means a fog value immediately after 5 k printing test using the ISO19752 standard test chart, and fog immediately after high printing means a fog value of 50th sheet when feeding A4-sized paper with a printing rate of 25% after a 5 k fog test.
Excellent: 0.5 or less (possible to use practically)
Good: more than 0.5 and 1.0 or less (possible to use practically)
Fair: more than 1.0 and 1.5 or less (possible to use practically)
Poor: more than 1.5 (impossible to use practically)

Evaluation 5: Friction Fastness

Each two component developer was charged into a commercially available copying machine (manufactured by Sharp Corporation, model: MX-5111FN) having a developing device, and a full solid image was printed on an intermediate recording medium (manufactured by Sharp Corporation, product name: PPC paper SF-4AM3).

The dye in the toner of the printed object on the obtained intermediate recording medium was sublimated and transferred onto the following three kinds of fabric under conditions where the set temperature was 205° C., the set pressure was 233 g/cm², and the period was 60 seconds using a plane-type sublimation transfer device (manufactured by HASHIMA CO., LTD., model: HSP-126FA), and the obtained fabric was subjected to heat-press drying at a temperature of 180° C. for 35 seconds to obtain test fabric.
Fabric 1: PET tromat (thick polyester fabric subjected to eyelet hole processing and French seam processing)
Fabric 2: T/C mix (fabric in which polyester and cotton are blended and spun)
Fabric 3: cotton broadcloth (glossy plain-woven fabric with high cotton density)

The obtained test fabric was subjected to a drying test (dry friction) and a moistening test (wet friction) using II-type (Gakushin-type) friction tester (manufactured by TESTER SANGYO CO., LTD., model: Gakushin-type friction tester) in accordance with test methods for color fastness to rubbing JIS L0849:2013, the staining degree of white fabric was determined based on comparison with a staining gray scale, and the friction fastness was evaluated according to the following criteria.
Excellent: grade 4.5 or greater (excellent)
Good: grade 4 (good)
Fair: grade 3 (possible to use)
Poor: grade 2 or lower (impossible to use)

Comprehensive Evaluation

The results in evaluation 1 to evaluation 5 descried above were scored such that “excellent” was considered as +2, “good” was considered as +1, “fair” was considered as ±0, and “poor” was considered as −1, and comprehensive evaluation was made on the basis of the total scores thereof, according to the following criteria.
Excellent: total score was 8 to 10 (possible to use)
Good: total score was 6 to 7 (possible to use)
Fair: total score was 0 to 5 (possible to use)
Poor: one or more results were rated as “poor” (impossible to use)

Materials and contents thereof used for preparing the toners of Examples and Comparative Examples are shown in Table 1, and evaluation results of the obtained toners are shown in Table 2.

The following abbreviations are used in Tables 1 and 2.
PEs: polyester-based resin
PVB: polyvinyl butyral resin
Aliphatic PEs: aliphatic polyester-based resin
Crystalline PEs: crystalline polyester-based resin
WAX: wax
Saturated linear AL: fully saturated linear alcohol

TABLE 1

| | Toner base particles (mass %) | | | | | | | | | External additive | |
|---|---|---|---|---|---|---|---|---|---|---|---|
| | | | | | Disperse | | | | | Hydro- | |
| | Binder resin | | | | dye | Charge | Mold | Additive | | phobic | |
| | | | Ali- | Crystall- | Sublim- | control | release | Saturated | Fatty | silica | |
| | | | phatic | ine | able | agent | agent | linear | acid | fine | Hydro- |
| | PEs | PVB | PEs | PEs | dye | (CCA) | WAX | AL | ketone | particles | talcite |
| Example 1 | 40.0 | — | 45 | — | 6 | 1 | 8.0 | — | — | 1.5 | — |
| Example 2 | 65.0 | — | 20 | — | 6 | 1 | 8.0 | — | — | 1.5 | — |
| Example 3 | 15.0 | — | 70 | — | 6 | 1 | 8.0 | — | — | 1.5 | — |
| Example 4 | 40.0 | — | 44 | 1 | 6 | 1 | 8.0 | — | — | 1.5 | — |
| Example 5 | 40.0 | — | 43 | 2 | 6 | 1 | 8.0 | — | — | 1.5 | — |
| Example 6 | 40.0 | — | 35 | 10 | 6 | 1 | 8.0 | — | — | 1.5 | — |
| Example 7 | 40.0 | — | 30 | 15 | 6 | 1 | 8.0 | — | — | 1.5 | — |
| Example 8 | 46.5 | — | 45 | — | 6 | 1 | 1.5 | — | — | 1.5 | — |
| Example 9 | 46.0 | — | 45 | — | 6 | 1 | 2.0 | — | — | 1.5 | — |
| Example 10 | 33.0 | — | 45 | — | 6 | 1 | 15.0 | — | — | 1.5 | — |
| Example 11 | 28.0 | — | 45 | — | 6 | 1 | 20.0 | — | — | 1.5 | — |
| Example 12 | 40.0 | — | 35 | — | 6 | 1 | 8.0 | — | — | 1.5 | — |
| Example 13 | 50.0 | — | 35 | — | 6 | 1 | 7.0 | 1 | — | 1.5 | — |
| Example 14 | 50.0 | — | 35 | — | 6 | 1 | 7.0 | 8 | — | 1.5 | — |
| Example 15 | 43.0 | — | 35 | — | 6 | 1 | 5.0 | 10 | — | 1.5 | — |
| Example 16 | 41.0 | — | 45 | — | 6 | 1 | 6.0 | — | 1 | 1.5 | — |
| Example 17 | 35.0 | — | 50 | — | 6 | 1 | 6.0 | — | 2 | 1.5 | — |
| Example 18 | 38.0 | — | 45 | — | 6 | 1 | 5.0 | — | 5 | 1.5 | — |
| Example 19 | 38.0 | — | 45 | — | 6 | 1 | 4.0 | — | 6 | 1.5 | — |

TABLE 2

| | Toner base particles (mass %) | | | | | | | | | External additive | |
|---|---|---|---|---|---|---|---|---|---|---|---|
| | | | | | Disperse | | | | | Hydro- | |
| | Binder resin | | | | dye | Charge | Mold | Additive | | phobic | |
| | | | Ali- | Crystall- | Sublim- | control | release | Saturated | Fatty | silica | |
| | | | phatic | ine | able | agent | agent | linear | acid | fine | Hydro- |
| | PEs | PVB | PEs | PEs | dye | (CCA) | WAX | AL | ketone | particles | talcite |
| Example 20 | 39.0 | 1 | 45 | — | 6 | 1 | 8.0 | — | — | 1.5 | — |
| Example 21 | 38.0 | 2 | 45 | — | 6 | 1 | 8.0 | — | — | 1.5 | — |
| Example 22 | 35.0 | 5 | 45 | — | 6 | 1 | 8.0 | — | — | 1.5 | — |
| Example 23 | 34.0 | 6 | 45 | — | 6 | 1 | 8.0 | — | — | 1.5 | — |
| Example 24 | 40.0 | — | 45 | — | 6 | 1 | 8.0 | — | — | 1.5 | — |
| Example 25 | 40.0 | — | 45 | — | 6 | 1 | 8.0 | — | — | 1.5 | 0.1 |
| Example 26 | 40.0 | — | 45 | — | 6 | 1 | 8.0 | — | — | 1.5 | 0.4 |
| Example 27 | 40.0 | — | 45 | — | 6 | 1 | 8.0 | — | — | 1.5 | 0.5 |
| Comparative | 66.0 | 4 | 15 | — | 6 | 1 | 8.0 | — | — | 1.5 | — |
| Example 1 | | | | | | | | | | | |
| Comparative | 14.0 | — | 71 | — | 6 | 1 | 0.0 | 8 | — | 1.5 | — |
| Example 2 | | | | | | | | | | | |
| Comparative | 53.0 | — | 19 | 11 | 6 | 1 | 9.0 | — | 1 | 1.5 | — |
| Example 3 | | | | | | | | | | | |
| Comparative | 3.0 | — | 75 | — | 6 | 1 | 7.0 | 8 | — | 1.5 | — |
| Example 4 | | | | | | | | | | | |
| Comparative | 66.0 | — | 15 | — | 6 | 1 | 8.0 | — | 4 | 1.5 | — |
| Example 5 | | | | | | | | | | | |

TABLE 3

| | Evaluation | | Evaluation 3 | | | | Evaluation | |
|---|---|---|---|---|---|---|---|---|
| | 1 | Evaluation | Sublimation transfer | | Evaluation 4 | | 5 | |
| | Preservation | 2 | efficiency | | Fog | | Friction | Total |
| | stability | Filming | (%) | Evaluation | (Difference) | Evaluation | fastness | evaluation |
| Example 1 | Excellent | Excellent | 62 | Excellent | 0.3 | Excellent | Excellent | Excellent |
| Example 2 | Excellent | Excellent | 49 | Good | 0.2 | Excellent | Excellent | Excellent |
| Example 3 | Excellent | Excellent | 60 | Excellent | 0.6 | Good | Excellent | Excellent |
| Example 4 | Excellent | Excellent | 61 | Excellent | 0.2 | Excellent | Excellent | Excellent |
| Example 5 | Excellent | Excellent | 66 | Excellent | 0.2 | Excellent | Excellent | Excellent |
| Example 6 | Excellent | Excellent | 59 | Excellent | 0.4 | Excellent | Excellent | Excellent |
| Example 7 | Good | Excellent | 49 | Good | 0.4 | Excellent | Excellent | Excellent |
| Example 8 | Excellent | Excellent | 49 | Good | 0.3 | Excellent | Fair | Good |
| Example 9 | Excellent | Excellent | 54 | Excellent | 0.3 | Excellent | Good | Excellent |
| Example 10 | Good | Good | 51 | Excellent | 0.4 | Excellent | Excellent | Excellent |
| Example 11 | Good | Fair | 55 | Excellent | 0.4 | Excellent | Excellent | Good |
| Example 12 | Excellent | Excellent | 47 | Good | 0.5 | Excellent | Fair | Good |
| Example 13 | Excellent | Good | 52 | Excellent | 0.4 | Excellent | Good | Excellent |
| Example 14 | Good | Good | 54 | Excellent | 0.7 | Good | Good | Good |
| Example 15 | Fair | Fair | 59 | Excellent | 0.3 | Excellent | Good | Fair |
| Example 16 | Excellent | Excellent | 61 | Excellent | 0.3 | Excellent | Fair | Good |
| Example 17 | Good | Good | 64 | Excellent | 0.8 | Good | Good | Good |
| Example 18 | Good | Good | 62 | Excellent | 0.3 | Excellent | Good | Good |
| Example 19 | Fair | Fair | 58 | Excellent | 0.4 | Excellent | Excellent | Fair |
| Example 20 | Excellent | Excellent | 51 | Excellent | 0.3 | Excellent | Excellent | Excellent |
| Example 21 | Good | Excellent | 59 | Excellent | 0.2 | Excellent | Good | Excellent |
| Example 22 | Good | Good | 54 | Excellent | 0.3 | Excellent | Good | Good |
| Example 23 | Fair | Good | 56 | Excellent | 0.4 | Excellent | Fair | Fair |
| Example 24 | Excellent | Good | 52 | Excellent | 0.4 | Excellent | Good | Excellent |
| Example 25 | Excellent | Excellent | 48 | Good | 0.4 | Excellent | Good | Excellent |
| Example 26 | Good | Good | 47 | Good | 0.3 | Excellent | Excellent | Good |
| Example 27 | Good | Good | 48 | Good | 0.9 | Good | Excellent | Good |
| Comparative | Excellent | Poor | 38 | Poor | 1.2 | Fair | Good | Poor |
| Example 1 | | | | | | | | |
| Comparative | Poor | Good | 43 | Fair | 1.3 | Fair | Good | Poor |
| Example 2 | | | | | | | | |
| Comparative | Good | Good | 34 | Poor | 0.7 | Good | Good | Poor |
| Example 3 | | | | | | | | |
| Comparative | Poor | Fair | 42 | Fair | 1.6 | Poor | Poor | Poor |
| Example 4 | | | | | | | | |
| Comparative | Excellent | Poor | 36 | Poor | 0.7 | Good | Good | Poor |
| Example 5 | | | | | | | | |

Tables 1 to 3 reveal the following.

(1) The developers including the toner of the present disclosure can provide a printing toner containing sublimable dye capable of dyeing a material to be dyed at a high concentration with high transfer efficiency by a sublimation transfer method in an electrophotographic manner (Examples 1 to 27).

(2) Since the aliphatic polyester-based resin is a polycondensate of a carboxylic acid component and an alcohol component containing an aliphatic diol having a hydroxy group binding to a secondary carbon atom, the developers including the toner of the present disclosure can provide a printing toner containing sublimable dye allowing dyeing at a high concentration with higher transfer efficiency (Examples 1 to 27).

(3) Since the toner base particles include the binder resin in a proportion of 50% to 95% by mass in the toner base particles, and the toner base particles include, as the binder resin, an aliphatic polyester-based resin in a proportion of 20% to 70% by mass in the toner base particles, the amount of non-crystalline polyester inhibiting sublimation of the sublimable dye is reduced, and the developers including the toner of the present disclosure can provide a printing toner containing sublimable dye allowing dyeing at a high concentration with higher transfer efficiency (Examples 1 to 3 and Comparative Examples 1 to 5).

The above result cannot be obtained even when the toner base particles includes the polyvinyl butyral resin in a proportion of 4% by mass in the toner base particles (Comparative Example 1), when the toner base particles further include the fully saturated linear alcohol as the sublimation transfer efficiency improving agent in a proportion of 8% by mass in the toner base particles (Comparative Examples 2 and 4), when the toner base particles include the crystalline polyester-based resin and the fatty acid ketone as the sol agent in a proportion of 11% by mass and a proportion of 1% by mass, respectively, in the toner base particles (Comparative Example 3), or when the toner base particles further include the fatty acid ketone as the sol agent in a proportion of 4% by mass (Comparative Example 5).

(4) Since the toner base particles include the crystalline polyester-based resin in a proportion of 2% to 10% by mass in the toner base particles, the developers including the toner of the present disclosure allowing dyeing at a high concentration with higher transfer efficiency because of compatibility between the dye and crystalline polyester (Examples 4 to 7).

(5) Since the mold release agent is wax, and the toner base particles include the mold release agent in a proportion of 5% to 15% by mass in the toner base particles, the developers including the toner of the present disclosure suppress migration of the binder resin of the toner to fabric during the sublimation transfer step and improve friction fastness (Examples 8 to 12).

(6) Since the toner base particles further include the fully saturated linear alcohol as the sublimation transfer efficiency improving agent in a proportion of 1% to 8% by mass in the toner base particles, the fully saturated linear alcohol and the dye are compatible with each other, the fully saturated linear alcohol and the dye, which are compatible with each other, are transferred to a toner layer surface during heating, and the developers including the toner of the present disclosure thus allow dyeing at a high concentration with higher transfer efficiency (Examples 13 to 15).

(7) Since the toner base particles further include the fatty acid ketone as the sol agent in a proportion of 2% to 5% by mass in the toner base particles, the polyester resin as the binder resin and the fatty acid ketone are compatible with each other, intermolecular force between the polyester resin and the dye is weakened thereby, and sublimation transfer efficiency improves in the developers including the toner of the present disclosure (Examples 16 to 19).

(8) Since the toner base particles include the polyvinyl butyral resin in a proportion of 2% to 5% by mass in the toner base particles, the dye is successfully dispersed in the polyvinyl butyral resin, the dye in a monodisperse state easily sublimates, and sublimation transfer efficiency improves in the developers including the toner of the present disclosure (Examples 20 to 24).

(9) Since the external additive is externally added to the toner base particles in a proportion of 0.01% to 5.0% by mass, and the hydrotalcite is externally added to the toner base particles in a proportion of 0.1% to 0.4% by mass, the dye having been bled out is trapped by the hydrotalcite, and preservation stability that has deteriorated due to tangle of the toner and the dye having been bled out during preservation at high temperature improves in the developers including the toner of the present disclosure (Examples 25 to 27).

What is claimed is:

1. A printing toner containing sublimable dye comprising:
toner base particles at least including a binder resin, a disperse dye, and a mold release agent; and
an external additive externally added to surfaces of the toner base particles, wherein
the toner base particles include the binder resin in a proportion of 50% to 95% by mass in the toner base particles, and include, as the binder resin, an aliphatic polyester-based resin in a proportion of 20% to 70% by mass in the toner base particles; and
the disperse dye is a sublimable dye.

2. The printing toner containing sublimable dye according to claim 1, wherein
the aliphatic polyester-based resin is a polycondensate of a carboxylic acid component and an alcohol component containing an aliphatic diol having a hydroxy group binding to a secondary carbon atom.

3. The printing toner containing sublimable dye according to claim 1, wherein
the toner base particles include a crystalline polyester-based resin in a proportion of 2% to 10% by mass in the toner base particles.

4. The printing toner containing sublimable dye according to claim 1, wherein
the mold release agent is a wax, and
the wax is included in the toner base particles in a proportion of 5% to 15% by mass.

5. The printing toner containing sublimable dye according to claim 1, wherein
the toner base particles further include a fully saturated linear alcohol as a sublimation transfer efficiency improving agent in a proportion of 1% to 8% by mass in the toner base particles.

6. The printing toner containing sublimable dye according to claim 1, wherein
the toner base particles further include, as a sol agent, a fatty acid ketone in a proportion of 2% to 5% by mass in the toner base particles.

7. The printing toner containing sublimable dye according to claim 1, wherein
the toner base particles include a polyvinyl butyral resin in a proportion of 2% to 5% by mass in the toner base particles.

8. The printing toner containing sublimable dye according to claim 1, wherein
an external additive is externally added to the toner base particles in a proportion of 0.01% to 5.0% by mass based on the toner base particles, and
a hydrotalcite is externally added to the toner base particles in a proportion of 0.1% to 0.4% by mass based on the toner base particles.

9. A two component developer comprising the printing toner containing sublimable dye according to claim 1 and a carrier.
